(19) United States
(12) Patent Application Publication
(10) Pub. No.: US 2015/0199788 A1
(43) Pub. Date: Jul. 16, 2015

(54) ACCELERATING GRAPHICAL RENDERING THROUGH LEGACY GRAPHICS COMPILATION

(71) Applicant: Christopher WOLFE, Kitchener (CA)

(72) Inventor: Christopher WOLFE, Kitchener (CA)

(73) Assignee: GOOGLE INC., Mountain View, CA (US)

(21) Appl. No.: 13/445,801

(22) Filed: Apr. 12, 2012

(51) Int. Cl. G06T 1/20; G06F 9/45; G06T 1/60

(52) U.S. Cl. CPC G06T 1/20; G06T 1/60; G06F 8/41

(57) ABSTRACT

A computer-implemented method for accelerating graphical rendering through legacy graphics compilation is provided. The method includes analyzing one or more graphics API calls of one or more frames of a scene to determine a sequence of graphics API calls which are likely to be unchanged, and translating the determined sequence of graphics API calls into a group of graphics processing unit (GPU) instructions. The method also includes storing the group of GPU instructions in a memory, and rendering a subsequent frame that is subsequent to the one or more analyzed frames using the stored group of GPU instructions. Systems and computer-readable media are also provided.

### TECHNICAL FIELD

The present disclosure generally relates to graphical rendering, and more particularly to accelerating graphical rendering through legacy graphics compilation.

### BACKGROUND

Applications such as, for example, web browsers and computer games, render graphics through graphical processing units (GPUs). Graphics application programming interfaces (APIs) may be provided in order to facilitate the interaction between the applications and the GPUs in rendering the graphics.

### SUMMARY

The disclosed subject technology relates to a computer-implemented method for accelerating graphical rendering through legacy graphics compilation. The method includes analyzing one or more graphics application programming interface (API) calls of one or more frames of a scene to determine a sequence of graphics API calls which are likely to be unchanged, and translating the determined sequence of graphics API calls into a group of graphics processing unit (GPU) instructions. The method also includes storing the group of GPU instructions in a memory, and rendering a frame subsequent to the one or more frames using the stored group of GPU instructions.

The disclosed subject technology further relates to a system for accelerating graphical rendering through legacy graphic compilation. The system includes a memory storing executable instructions. The system also includes a processor coupled to the memory configured to execute the stored executable instructions to analyze one or more graphics application programming interface (API) calls of one or more frames of a scene to determine a sequence of graphics API calls which are likely to be unchanged, and translate the determined sequence of graphics API calls into a group of graphics processing unit (GPU) instructions. The processor is also configured to store the group of GPU instructions in a memory, render a frame subsequent to the one or more frames using the stored group of GPU instructions, and render another frame subsequent to the rendered frame subsequent to the one or more frames using the stored group of GPU instructions.

The disclosed subject technology also relates to a machine-readable storage medium comprising machine-readable instructions for causing a processor to execute a method for accelerating graphical rendering through legacy graphics compilation. The method includes analyzing one or more graphics application programming interface (API) calls of one or more frames of a scene to determine a sequence of graphics API calls which are likely to be unchanged, validating the determined sequence of graphics API calls, and translating the determined sequence of graphics API calls into a group of graphics processing unit (GPU) instructions. The method also includes storing the group of GPU instructions in a memory, and rendering a frame subsequent to the one or more frames using the stored group of GPU instructions and parameters associated with the subsequent frame. The method also includes rendering another frame subsequent to the rendered frame subsequent to the one or more frames using the stored group of GPU instructions and parameters associated with the another frame.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purposes of explanation, several aspects of the subject technology are set forth in the following figures.

FIG. 1 illustrates an example architecture for accelerating graphical rendering through legacy graphics compilation.

FIG. 2 is a block diagram illustrating an example system for accelerating graphical rendering through legacy graphics compilation.

FIG. 3 is a schematic diagram illustrating example operations for accelerating graphical rendering through legacy graphics compilation.

FIG. 4 illustrates an example flow diagram of example processes for accelerating graphical rendering through legacy graphics compilation.

FIG. 5 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Applications such as, for example, web browsers, computer games or other computer programs displaying graphics, may utilize a graphics application programming interface (API) in order to communicate with a graphical processing unit (GPU) to render graphics. The graphics API may be, for example, OpenGL, OpenGL ES and WebGL. To depict a scene which may change over time, the rendering of graphics may include rendering multiple frames. The frames may be rendered at the rate of multiple times per second, often tens of times per second. Typically, the frames are rendered at a rate of 30 or 60 frames per second, although other frame rates may also be used. The graphics APIs that the applications use for rendering the scenes may require that graphics API calls and their underlying processing be newly performed each time a frame of a scene is rendered.

The underlying processes for each graphics API call include translating the calls into machine instructions which may be understood and executed by a GPU. The process may also include translating the graphics API calls first into instructions for a virtual GPU, verifying the instructions for the virtual GPU, and then translating the instructions into the machine instructions. The intermediate step of verifying the instructions for the virtual GPU helps improve security and portability across different platforms. Thousands of graphics API calls may be made for rendering each frame. Therefore, improving the efficiency of the graphics API calls and their translation into machine instructions may help improve overall efficiency of the graphics rendering.

A scene may be caused to be rendered by an application by making a series of graphics API calls. Such series of graphics API calls may be hard-coded in the application. The series of graphics API calls may also be made by traversing a scene graph. The scene graph contains information about the scene which the application in conjunction with a GPU may use in rendering the scene. Applications may also utilize a render tree, which is a particular form of a scene graph. The scene graph includes one or more nodes representing particular aspects of a scene. The nodes may be associated with, and cause the application to make, particular graphics API calls. In rendering the scene graph, the application traverses the nodes of the scene graph, makes the graphics API calls associated with the nodes, and such graphics API calls are then ultimately translated into machine instructions which may be executed by the GPU. The machine instructions that may be executed by a GPU may also be called GPU instructions.

The phrase “scene graph” as used herein encompasses its plain and ordinary meaning, including, but not limited to, a data structure describing various aspects of a scene for rendering. The scene graph may be a tree data structure having one or more nodes organized into different branches. In rendering a scene, the nodes of the scene graph may be traversed in a certain manner, rendering the scene based on data contained in the nodes as they are traversed. Each node of the scene graph may correspond to different elements or objects of the rendered scene. The structure of portions of the scene graph may change as the scene is rendered for different frames to reflect the changes that are made as the scene progresses through the frames.

According to various aspects of the subject technology, a method and system for accelerating graphical rendering through legacy graphics compilation is provided. Rendering of a series of graphics API calls is accelerated by re-using GPU instructions generated for a certain sequence of graphics API calls. Rather than newly generating GPU instructions for every graphics API call, the generated GPU instructions may be repeatedly used if the structure of the certain sequence of graphics API calls associated with the GPU instructions does not change. Changes to the rendered frames that do not involve a structural change to the sequence of graphics API calls (e.g., objects changing only in position) may be handled by supplying different parameters to the re-used GPU instructions.

As the application makes a series of graphics API calls for rendering a scene, the graphics API calls are caused to be translated into GPU instructions. The translated GPU instructions are placed into a command buffer for execution by a GPU. This process is analyzed for one or more frames, and a determination is made as to groups of GPU instructions placed in the command buffer corresponding to a sequence of graphics API calls (and their corresponding nodes) which may be preserved and repeatedly used. Since the groups of GPU instructions for preservation and reuse is determined by analyzing the rendering of one or more frames, the application need not store information for determining the preserved and reused groups of GPU instructions.

Various heuristics and pattern matching techniques may be used to determine the group of GPU instructions that may be preserved and reused. For example, if the same sequence of graphics API calls is made in one frame after another during the frames that are analyzed, the group of GPU instructions generated from the sequence of graphics API calls may be determined as a group which may be preserved and reused. Also, the nature of the graphics API calls and the structure of the scene graph may also be used to determine the re-usable groups of GPU instructions. For example, for graphics API calls typically associated with background objects which are known to be constant throughout the frames, the groups of GPU instructions corresponding to such graphics API calls may also be preserved and reused. Typically, the determination of preserved and reused groups of GPU instructions may be made after analyzing one or two frames.

The heuristics and the pattern matching techniques may determine the reusable GPU instruction groups such that the corresponding sequence of graphics API instructions is less likely to undergo structural changes, or is likely to undergo structural changes at the same time. Examples of a change to a scene which may be associated with a structural change to the sequence of graphics API calls may include, but is not limited to, an object being newly created (e.g., a new character being introduced into the scene) and an object being deformed (e.g., a rock which has exploded).

Other types of information may be used in determining the re-usable GPU instruction groups. For example, the presence of a specific graphics API call may be used as an indicator which suggests that a sequence of graphics API calls including the specific graphics API call will translate into a group of GPU instructions which will likely be determined for preservation and reuse. Therefore, the presence of the specific graphics API call may be used to augment and/or override the determination of groups of GPU instructions for preservation and reuse made by analyzing the one or more frames.

The analysis to determine the groups of GPU instructions for preservation and reuse may be made on one or more initial frames of a scene. The analysis is not limited to the initial frames, however. The application may not perform the analysis for a predetermined number of frames before performing the analysis. Also, after performing a first analysis on one or more frames, the application may perform another analysis for one or more later frames if a structural change occurs in the sequence of graphics API calls for which the corresponding groups of GPU instructions that were determined for preservation and reuse from the first analysis. The groups for which the sequence of graphics API calls have undergone a structural change may be discarded, and new analysis will be made to determine new groups of GPU instructions for preservation and reuse. The groups corresponding to the sequences of graphics API calls that have not undergone structural changes will be kept. Depending on the new analysis, two or more existing groups of GPU instructions determined for preservation and reuse may be merged together as one group, or a single group may be split into multiple groups.

Each re-useable group of GPU instructions may be placed in the command buffer, and may be managed as a command buffer object (CBO). A CBO is a group of GPU instructions which are grouped into a logical unit which may be placed in a command buffer and executed by a GPU. Once a CBO has been determined by analyzing the initial frames, the same CBO may be reused in subsequent frames for the same sequence of graphics API calls. Only the CBOs for which the corresponding sequence of graphics API calls has undergone structural changes are regenerated. Common changes that do not involve structural changes to the sequence of graphics API calls (e.g., objects that are moving and changing colors of objects) do not require regenerating the CBO, and only updating the parameters that are passed on to the existing CBO is needed.

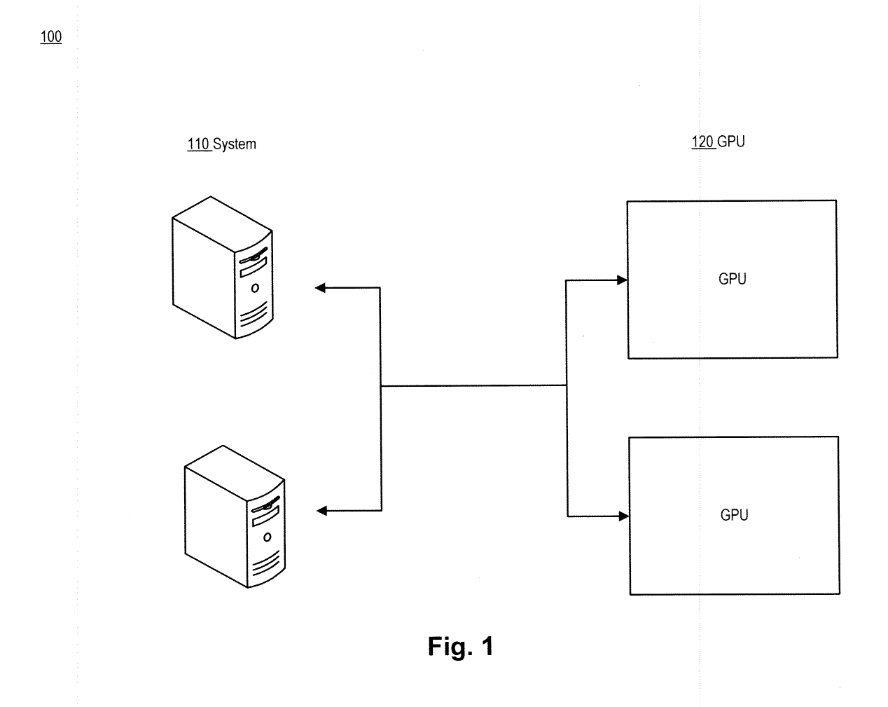

FIG. 1 illustrates an example architecture 100 for accelerating graphical rendering through legacy graphics compilation. The architecture 100 includes systems 110 and GPUs 120 in communication with each other. The systems 110 may interact with users to accelerate graphical rendering through legacy graphics compilation. The systems 110 may be any device having a processor, memory, and communications capability for communicating with the GPUs 120 for accelerating graphical rendering through scene graph compilation. For example, the GPUs 120 may be incorporated into one or more of the systems 110 and communicate with the internal elements of the systems 110 via a bus (not shown). The GPUs 120 may also be in communication with the systems 110 via a network (not shown). The network may include, for example, any one or more of a personal area network (PAN), a local area network (LAN), a campus area network (CAN), a metropolitan area network (MAN), a wide area network (WAN), a broadband network (BBN), the Internet, and the like. Further, the network can include, but is not limited to, any one or more of the following network topologies, including a bus network, a star network, a ring network, a mesh network, a star-bus network, tree or hierarchical network, and the like.

The GPUs 120 may be any computer hardware which stores logic for executing instructions for rendering graphics.

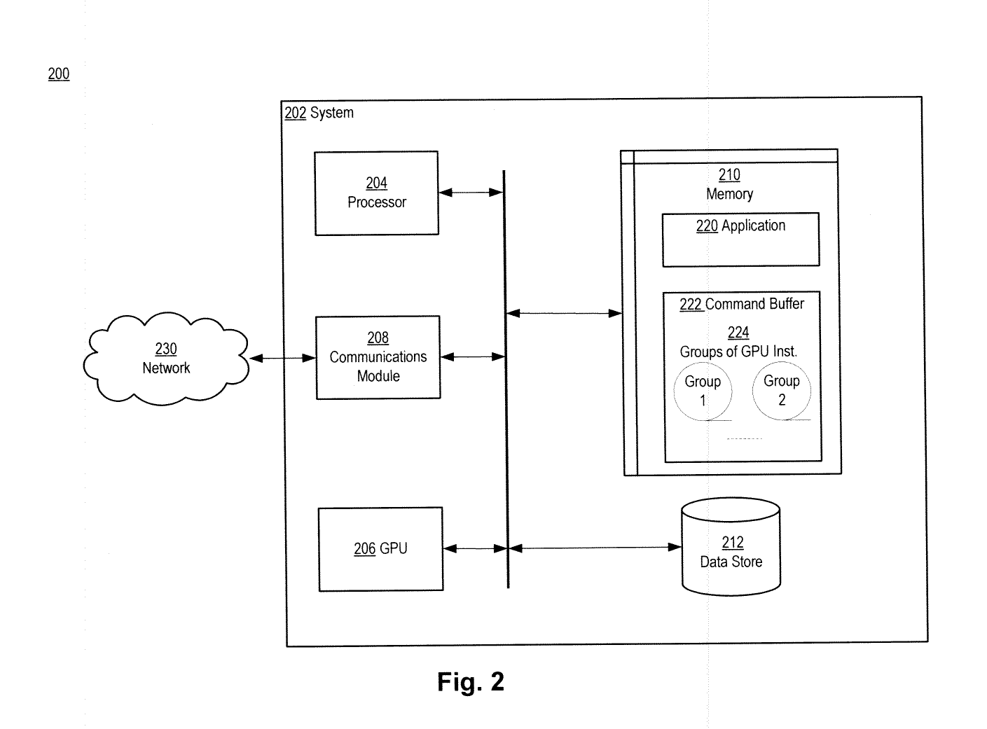

FIG. 2 is a block diagram 200 illustrating an example system 202 for accelerating graphical rendering through scene graph compilation. The system 202 may be implemented, for example, at one of systems 110 or across multiple systems 110. The system 202 may also incorporate a GPU 206 (e.g., GPUs 120). Diagram 200 shows that the GPU 206 is incorporated into the system 202. However, in an aspect of the subject technology, the GPU 206 may also be independent from the system 202 and may communicate with the system via a network 230 (e.g., the network discussed above with reference to FIG. 1). The system 202 may connect to the network 230 via a communications module 208.

The system 202 includes a processor 204, the GPU 206, the communications module 208, and memory 210. The communications module 208 is configured to interface with the network 230 to send and receive information, such as data, requests, responses, and commands to other devices or systems on the network 230. The communications module 208 may be, for example, modems, Ethernet cards or mobile broadband adaptors.

The memory 210 may include an application 220 which contains instructions for making a series of graphics API calls for rendering a scene. The series of graphics API calls may be made using a scene graph, or may be otherwise predetermined in the application 220. The application 220 may also be stored independently from the system 202 and be in communication with the system 202 via the network 230.

The memory 210 also includes a command buffer 222 which stores one or more groups of GPU instructions 224. Each group of GPU instructions 224 may be managed as, for example, a command buffer object (CBO). A CBO is a group of GPU instructions which are grouped into a logical unit which may be placed in a command buffer and executed by a GPU. While the rest of the present description may refer to the groups of GPU instructions as CBOs, other types or methods for managing or executing groups of GPU instructions may also be used. Each group of GPU instructions 224 are translated from a group of graphics API calls made based on instructions stored in the application 220.

System 202 may also include a data store 212, which may also include the command buffer 222 for storing the groups of GPU instructions 224. The data store 212 may be integrated with the memory 210, or may be independent from the memory and be in communication with the processor 204 and the memory. The data store 212 may also be implemented to be independent from the system 202 and in communication with the system.

The processor 204 is configured to execute instructions, such as instructions physically coded into the processor, instructions received in the form of software from the memory 210, or a combination of both. The processor 204 is also configured to execute instructions received from the application 220. For example, the processor 204 is configured to analyze one or more graphics API calls made for one or more frames of a scene to determine a sequence of graphics API calls which is likely to be unchanged. The processor 204 is also configured to compile the determined sequence of graphics API calls into a group of GPU instructions 224, and store the compiled group of GPU instructions in the memory 210. The processor 204 is further configured to access the stored group of GPU instructions 224 from the memory 210, and render a subsequent frame that is subsequent to the one or more frames using the accessed group of GPU instructions.

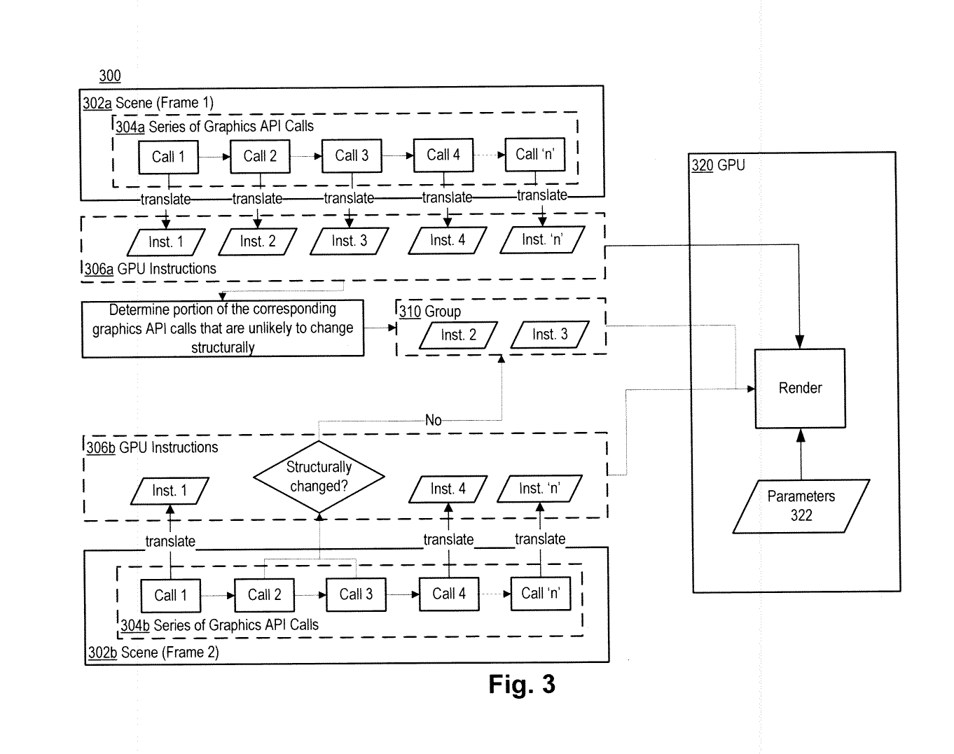

FIG. 3 is a schematic diagram 300 illustrating an example electronic operation for accelerating graphical rendering through legacy graphics compilation. The operation may be performed, for example, by the system 202. An application (e.g., application 220) may cause to render a scene for one or more frames by making a series of graphics API calls 304a. Diagram 300 shows that scene 302a is rendered for one frame, frame 1. In causing to render the scene 302a for frame 1, the application makes the series of graphics API calls 304a. After the application makes the graphics API calls, the calls are translated into GPU instructions 306a which may then be executed by a GPU 320 (e.g., GPUs 120). Before the graphics API calls 304a are translated into GPU instructions 306a, they may also be validated to ensure that the GPU instructions 306a may be properly executed by the GPU 320.

The GPU instructions 306a are analyzed to determine a group 310 of GPU instructions (e.g., one of a groups of GPU instructions 224) which corresponds to a sequence within the series of graphics API calls 304a which are unlikely to change structurally in the subsequent frames. Diagram 300 shows that instructions 2 and 3 which correspond to the sequence “call 2” and “call 3” of the series of graphics API calls 304a are determined as the group 310 of the GPU instructions. Group 310 may be stored in a memory (e.g., memory 210) or in a command buffer (e.g., command buffer 222) within the memory, for preservation and reuse. While diagram 300 shows that one frame (frame 1) is analyzed for determining the group 310 of GPU instructions, more than one frame may be analyzed to determine the group of GPU instructions. Also, while diagram 300 shows that one group of GPU instructions, group 310, is determined, more than one group of GPU instructions may also be determined and stored in the memory or in the command buffer of the memory.

The groups of GPU instructions (e.g., group 310) may be managed as CBOs. As discussed above, a CBO is a group of GPU instructions which are grouped into a logical unit which may be placed in a command buffer and executed by a GPU. The series of graphics API calls 304a may be analyzed to determine the group 310 such that the sequence of graphics API calls within the series of graphics API calls 304a that correspond to the group 310 are not likely to undergo a structural change, or are likely to undergo a structural change at the same time. Various factors may be used to determine the group 310, such as, for example, static properties of the scene 302a or heuristics. For example, individual graphics API calls of the series of graphics API calls 304a corresponding to a background image of the scene 302a which will not vary much from frame to frame may be grouped together as a sequence of graphics API calls that are translated into the group 310. Also, graphics API calls corresponding to a moving object which maintains its shape for a predetermined number of frames may be grouped together. As another example, graphics API calls corresponding to hypertext mark-up language (HTML) elements which appear and disappear from the screen at the same time may also be grouped together.

The group 310 may also be determined based on the presence of a specific graphics API call. For example, the presence of a predetermined graphics API call in a sequence of graphics API calls may be used as an indicator that the sequence will not likely undergo a structural change. This information may be used to augment or override the determination of the group 310 made by using other methods or schemes (e.g., static properties of the scene or heuristics). Information on such specific graphics API calls may be stored, for example, in the memory 210 or in the data store 212.

All GPU instructions 306a corresponding to all of the individual graphics API calls of the series of graphics API calls 304a of the scene graph 302a may be part of a group of GPU instructions (e.g., group 310), or some individual graphics API calls of the series of graphics API calls 304a may not be a part of any group of GPU instructions if it is determined that the graphics API calls are not suitable for being grouped together (e.g., are likely to undergo structural change). For example, graphics API calls of series 304a corresponding to an object which will explode in the scene 302a (e.g., a bomb in a computer game) are likely to undergo a structural change and their counterpart GPU instructions are not grouped into any groups of GPU instructions.

After group 310 is determined and the scene 302a for frame 1 has been rendered, the scene may be rendered for a subsequent frame, frame 2. If more than one frames were rendered to determine the group 310, then the frame subsequent to the last frame required for determining the group 310 is rendered. Scene 302b for frame 2 may be identical to scene 302a for frame 1, or may be different from the scene 302a for frame 1, depending on how the application is coded to render its scenes throughout the different frames. In rendering the scene 302b for frame 2, determination is made as to whether the sequence of graphics API calls in the series of graphics API calls 304b corresponding to the preserved group 310 has structurally changed. As with the scenes 302a and 302b, the sequence of graphics API calls 304a and 304b may also be identical or different depending on how the application is coded to render the scenes. If the sequence of graphics API calls 304b did not undergo a structural change as compared to the calls 304a, then rather than retranslating the “Call 2” and “Call 3” into GPU instructions 2 and 3, the preserved group 310 is accessed, retrieved, and rendered by the GPU 320. For graphics API calls in the series of graphics API calls 304b for which the corresponding GPU instructions have not been grouped together and preserved, the calls are newly translated into GPU instructions 306b, and are rendered by the GPU 320.

If it is determined that no structural change has occurred in the sequence of graphics API calls 304b corresponding to the preserved group 310, determination may be made whether there are any minor changes to the scene elements corresponding to the group 310 as compared with the previous frame. Parameters 322 may be supplied to the group 310 to address such minor changes. Such minor changes may be, for example, a change in location or position of the scene element (e.g., a projectile element that is spinning) and change in color. Specifically, in the case of a projectile, the value of the X and Y coordinates of the projectile may be supplied as the parameters 322. A data structure may be provided which keeps track of the groups 310 and their minor changes throughout the different frames that may be addressed with the parameters 322.

If the sequence of graphics API calls corresponding to the group 310 has undergone a structural change in the subsequent frame (e.g., frame 2 in diagram 300), the associated graphics API calls are then caused to be translated again into new GPU instructions and the stored group 310 of GPU instructions is not re-used. The new GPU instructions may be analyzed to determine if they may also be grouped into a new group of GPU instructions which may be preserved and reused. Analysis may also be made on other translated GPU instructions, group 310, or other existing groups of GPU instructions which had been determined and preserved in previous analyses, to determine whether any other new groups for preservation and reuse may be determined. Also, depending on the analysis, two or more existing groups may be merged into a single group, or a single group may be split into two or more groups.

As discussed above, the graphics API calls 304a may be divided into multiple groups 310. The division of the graphics API calls 304a into the groups 310 need not necessarily be the same for each frame, and the series of graphics API calls 304b for frame 2 may be divided differently and the corresponding GPU instructions 306b may be grouped into different groups as needed by the application making the graphics API calls. In addition, a group of GPU instructions (e.g., group 310) may execute other groups. Therefore, an arbitrary nested tree of groups of GPU instructions is also possible.

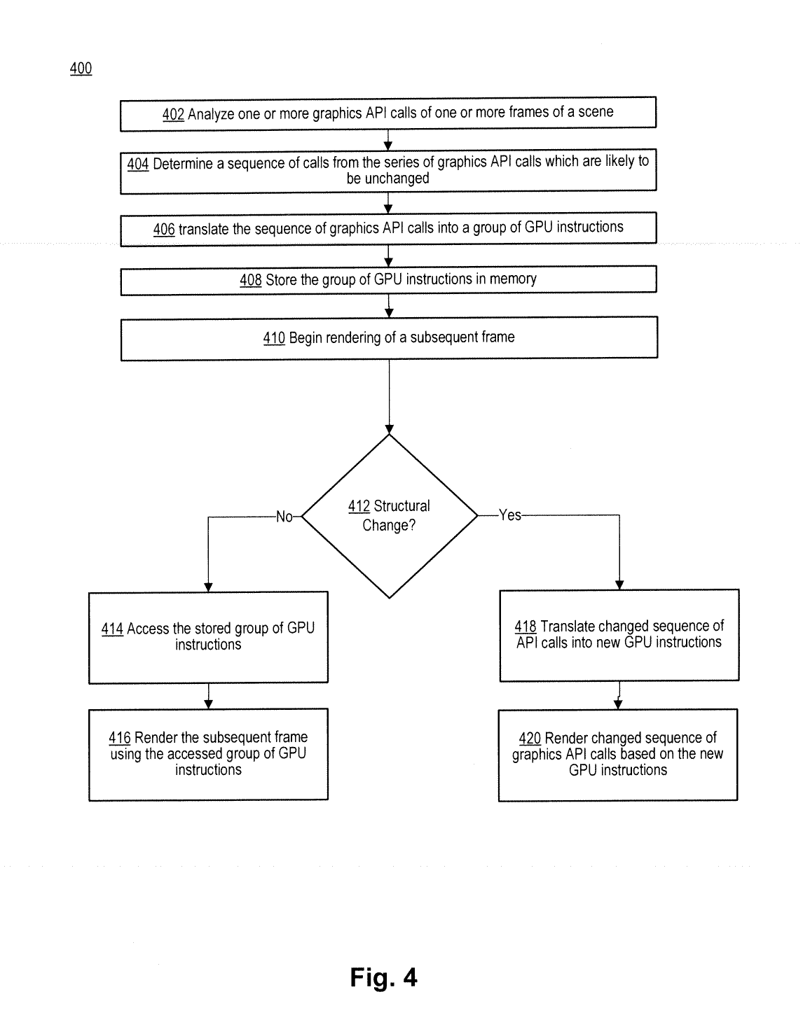

FIG. 4 illustrates an example flow diagram 400 of example processes for accelerating graphical rendering through legacy graphics compilation. The operations of FIG. 4 may be performed, for example, by the system 202.

The operation begins in step 402 where one or more graphics API calls (e.g., one of series of graphics API calls 304a) of one or more frames of a scene (e.g., scene 302a) are analyzed. In step 402, a sequence of graphics API calls from the series of graphics API calls (e.g., series of graphics API calls 304a) which are likely to be unchanged is determined. In step 406, the determined sequence of graphics API calls are translated into a group of GPU instructions (e.g., group 310). In step 408, the group of GPU instructions are stored in a memory (e.g., memory 210).

In step 410, rendering of a subsequent frame that is subsequent to the one or more frame begins. In step 412, determination is made whether the sequence of graphics API calls for the subsequent frame has changed structurally. If the sequence of graphics API calls has not changed structurally, in step 414, the stored group of GPU instructions is accessed from the memory. In step 416, the subsequent frame is rendered using the accessed group of GPU instructions.

If in step 412 the sequence of graphics API calls is changed structurally, then in step 418, the changed sequence of graphics API calls is newly translated into GPU instructions, and in step 420, the changed sequence is rendered based on the new GPU instructions.

Many of the above-described features and applications are implemented as software processes that are specified as a group of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include, but is not limited to, firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

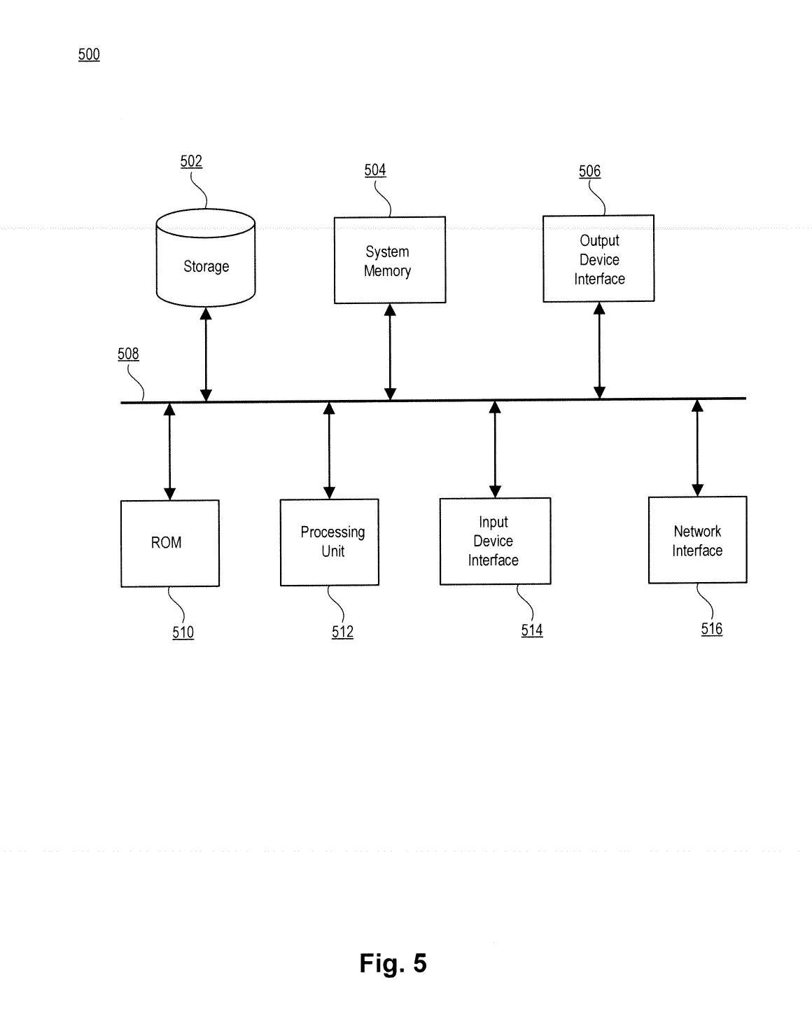

FIG. 5 conceptually illustrates an electronic system with which some implementations of the subject technology are implemented. Electronic system 500 can be a computer, phone, PDA, or any other sort of electronic device. Such an electronic system includes various types of computer-readable media and interfaces for various other types of computer-readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and static instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such as a random access memory. System memory 504 stores some of the instructions and data that the processor needs at runtime. In some implementations, the processes of the subject disclosure are stored in system memory 504, permanent storage device 502, and/or ROM 510. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interface 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessors or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer-readable medium” and “computer-readable media” are entirely restricted to tangible, physical objects that store information in a form that is readable by a computer. These terms exclude any wireless signals, wired download signals, and any other ephemeral signals.

To provide for interaction with a user, implementations of the subject technology described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user.

Aspects of the subject technology described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject technology described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that not all illustrated steps be performed. Some of the steps may be performed simultaneously. For example, in certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

1. A computer-implemented method for accelerating graphical rendering through legacy graphics compilation, the method comprising:
analyzing one or more graphics application programming interface (API) calls of one or more frames of a scene to determine a sequence of graphics API calls which are likely to be unchanged;
translating the determined sequence of graphics API calls into a group of graphics processing unit (GPU) instructions;
storing the group of GPU instructions as a command buffer object in a command buffer; and
rendering a subsequent frame that is subsequent to the one or more analyzed frames using the command buffer object.

2. The method of claim 1, wherein the subsequent frame is rendered using the command buffer object if the sequence of graphics API calls is not changed structurally for the subsequent frame.

3. The method of claim 1, further comprising rendering a frame subsequent to the subsequent frame using the command buffer object.

4. The method of claim 1, further comprising:
determining whether the sequence of graphics API calls is changed structurally for the subsequent frame;
if the sequence of graphics API calls is changed structurally for the subsequent frame, analyzing the one or more sequence of graphics API calls for the subsequent frame to determine a new sequence of graphics API calls which is likely to be unchanged;
translating the determined new sequence of graphics API calls into a new group of graphics processing unit (GPU) instructions; and
storing the new group of GPU instructions in the command buffer as a new command buffer object.

5. The method of claim 1, wherein the subsequent frame is rendered based on parameters associated with the subsequent frame.

6. The method of claim 5, wherein the parameters comprise information for reflecting a change to the rendered subsequent frame, the change corresponding to a non-structural change to the sequence of graphics API calls for the subsequent frame.

7. The method of claim 1, wherein the sequence of graphics API calls is determined based on static properties of the scene.

8. The method of claim 1, wherein the sequence of graphics API calls is determined based on heuristics.

9. The method of claim 1, wherein the sequence of graphics API calls is determined based on a predetermined graphics API call, wherein the presence of the predetermined graphics API call provides an indicator that the sequence of graphics API calls will not likely undergo a structural change.

10. The method of claim 1, wherein the one or more frames comprise one or more initial frames of the scene.

11. The method of claim 4, wherein the new command buffer object comprises two or more groups of GPU instructions merged into a single group of GPU instructions.

12. The method of claim 4, wherein the new command buffer object comprises one of a plurality of groups of GPU instructions split from a single group of GPU instructions.

13. (canceled)

14. The method of claim 1, wherein the translating the sequence of graphics API calls into the group of GPU instructions comprises validating the graphics API calls for compatibility with a GPU.

15. A system for accelerating graphical rendering through legacy graphics compilation, the system comprising:
a memory storing executable instructions; and
a processor coupled to the memory configured to execute the stored executable instructions to:
analyze one or more graphics application programming interface (API) calls of one or more frames of a scene to determine a sequence of graphics API calls which are likely to be unchanged;
translate the determined sequence of graphics API calls into a group of graphics processing unit (GPU) instructions;
store the group of GPU instructions as a command buffer object in a command buffer;
render a subsequent frame that is subsequent to the one or more analyzed frames using the command buffer object; and
render another frame subsequent to the rendered subsequent frame using the command buffer object.

16. The system of claim 15, wherein the subsequent frame is rendered using the command buffer object if the sequence of graphics API calls for the subsequent frame is not changed structurally.

17. The system of claim 15, wherein the subsequent frame is rendered based on parameters associated with the frame subsequent to the one or more frames.

18. The system of claim 15, wherein the sequence of graphics API calls is determined based on a predetermined graphics API call, wherein the presence of the predetermined graphics API call augments a determination of groups of GPU instructions for preservation and reuse made by analyzing the one or more frames.

19. The system of claim 15, wherein the sequence of graphics API calls is determined based on a predetermined graphics API call, wherein the presence of the predetermined graphics API call overrides a determination of groups of GPU instructions for preservation and reuse made by analyzing the one or more frames.

20. A machine-readable storage medium comprising machine-readable instructions for causing a processor to execute a method for accelerating graphical rendering through legacy graphics compilation, the method comprising:
analyzing one or more graphics application programming interface (API) calls of one or more frames of a scene to determine a sequence of graphics API calls which are likely to be unchanged;
validating the determined sequence of graphics API calls;
translating the determined sequence of graphics API calls into a group of graphics processing unit (GPU) instructions;
storing the group of GPU instructions as a command buffer object in a command buffer;
rendering a subsequent frame that is subsequent to the one or more frames using the command buffer object and parameters associated with the subsequent frame; and
rendering another frame subsequent to the rendered subsequent frame using the command buffer object and parameters associated with the another frame.

21. The method of claim 1, wherein the group of GPU instructions is configured to execute one or more other groups of GPU instructions.
